(19) United States
(12) Patent Application Publication
(10) Pub. No.: US 2026/0241585 A1
(43) Pub. Date: Aug. 20, 2026

(54) KNIFE

(71) Applicant: MADI, LLC, Greenville, SC (US)

(72) Inventor: Xuemin Wu, Azusa, CA (US)

(21) Appl. No.: 19/053,730

(22) Filed: Feb. 14, 2025

(51) Int. Cl. B26B 1/04

(52) U.S. Cl. CPC B26B 1/042

(57) ABSTRACT

A knife is disclosed. The knife including a housing; a blade holder connected to the housing; a blade in mating engagement with and releasably secured to the blade holder; and a blade release mechanism connected to the blade holder, the blade release mechanism securing the blade in the blade holder and releasing the blade when an actuator of the blade release mechanism is depressed.

### BACKGROUND OF THE INVENTION

This application relates to a knife and, more particularly, to a knife having a quick release blade.

Knives are used in both personal and industrial applications. One such industrial application is in the utility industry where linemen are in elevated positions and need to be able to efficiently change out knife blades while also having a knife where the blade is securely locked into the knife.

One of the problems with current quick release blades is that the blades, when in a locked position, can often times be difficult to release and/or are not stable within the knife. In other words, the blade can have a lot of play in the vertical and horizontal directions despite being secured in the knife.

### BRIEF SUMMARY OF THE INVENTION

This problem is addressed by a knife having a quick release system and/or blade that prevents movement in both the vertical and horizontal directions when secured in the knife.

According to an aspect of the invention, a knife includes a housing; a blade holder connected to the housing; a blade in mating engagement with and releasably secured to the blade holder; and a blade release mechanism connected to the blade holder, the blade release mechanism securing the blade in the blade holder and releasing the blade when an actuator of the blade release mechanism is depressed.

According to another aspect of the invention, a knife includes a housing; a blade holder connected to the housing, the blade holder defining a receptacle; a blade releasably secured in the receptacle of the blade holder, the blade having a rear tang for engagement with a pocket of the blade holder and a slot for engagement with a protrusion of the blade holder; and a blade release mechanism connected to the blade holder, the blade release mechanism securing the blade in the blade holder and releasing the blade when an actuator of the blade release mechanism is depressed.

According to another aspect of the invention, a knife includes a housing; a blade holder connected to the housing and defining a receptacle therein; a blade releasably secured to the blade holder, the blade including a mating portion, the mating portion mating with the receptacle of the blade holder when the blade is secured therein; and a blade release mechanism connected to the blade holder, the blade release mechanism securing the blade in the receptacle of the blade holder and releasing the blade when an actuator of the blade release mechanism is depressed.

### BRIEF DESCRIPTION OF THE DRAWINGS

The invention may be best understood by reference to the following description taken in conjunction with the accompanying drawing figures, in which:

FIG. 1 is a front perspective view of an exemplary knife, in an open position;

FIG. 2 is a rear perspective view of the knife of FIG. 1;

FIG. 3 is a left elevation of the knife of FIG. 1;

FIG. 4 is a right elevation of the knife of FIG. 1;

FIG. 5 is a right elevation of the knife of FIG. 1 showing a locking mechanism;

FIG. 6 is left elevation view of the knife of FIG. 1, in a closed position;

FIG. 7 shows a blade engaged with a blade holder of the knife of FIG. 1;

FIG. 8 shows a blade engaged with a blade holder of the knife of FIG. 1;

FIG. 9 is a perspective view of the blade holder of the knife of FIG. 1;

FIG. 10 shows a blade release mechanism of the knife of FIG. 1;

FIG. 11 is a perspective view of an actuator of the blade mechanism of FIG. 10; and

FIG. 12 shows the blade release mechanism of FIG. 10 engaged with the blade of the knife of FIG. 1.

### DETAILED DESCRIPTION OF THE INVENTION

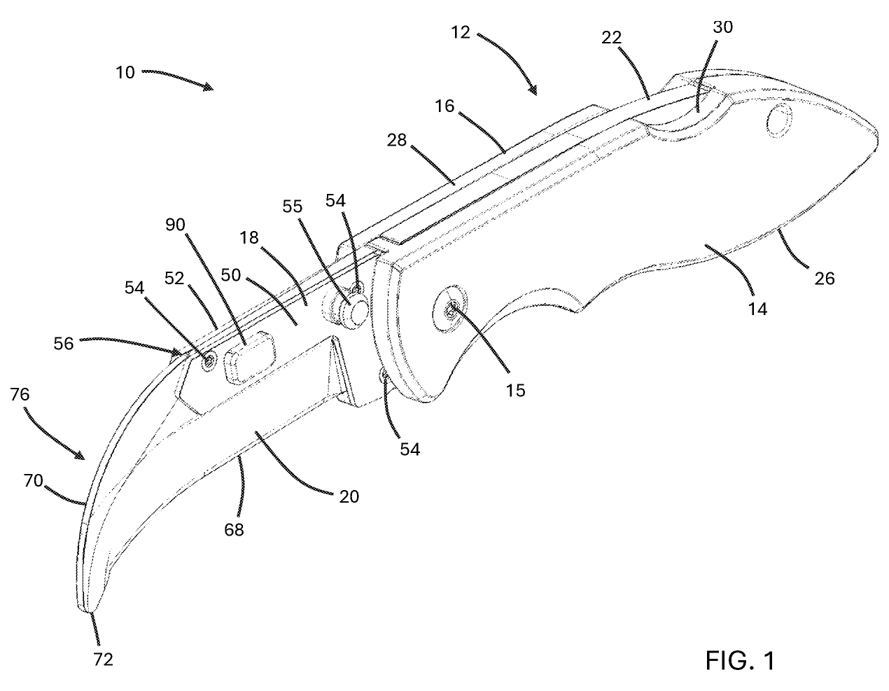

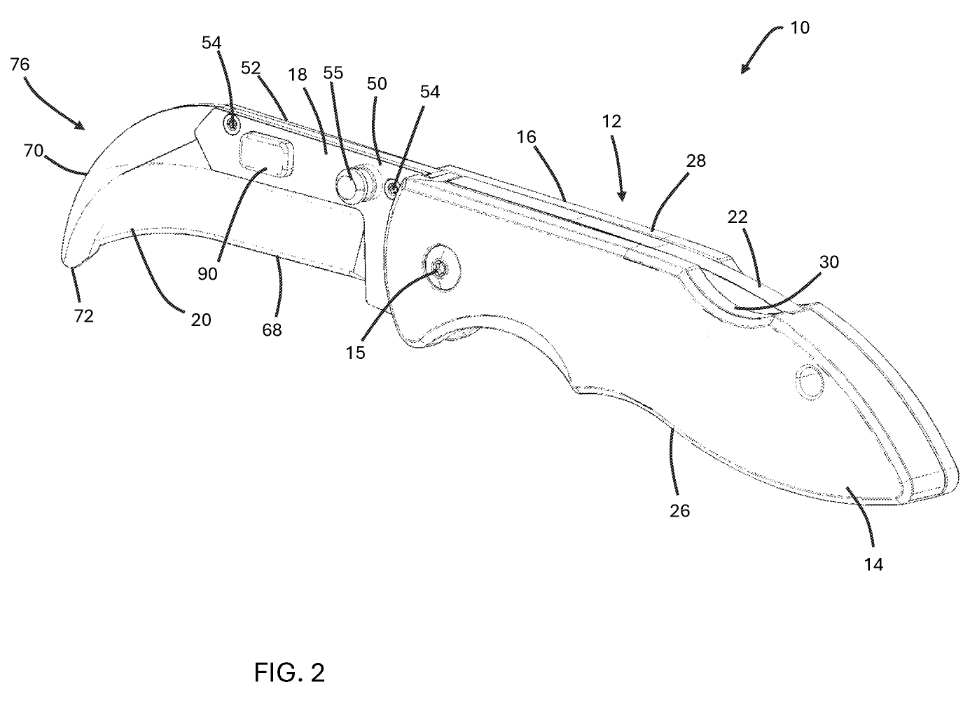

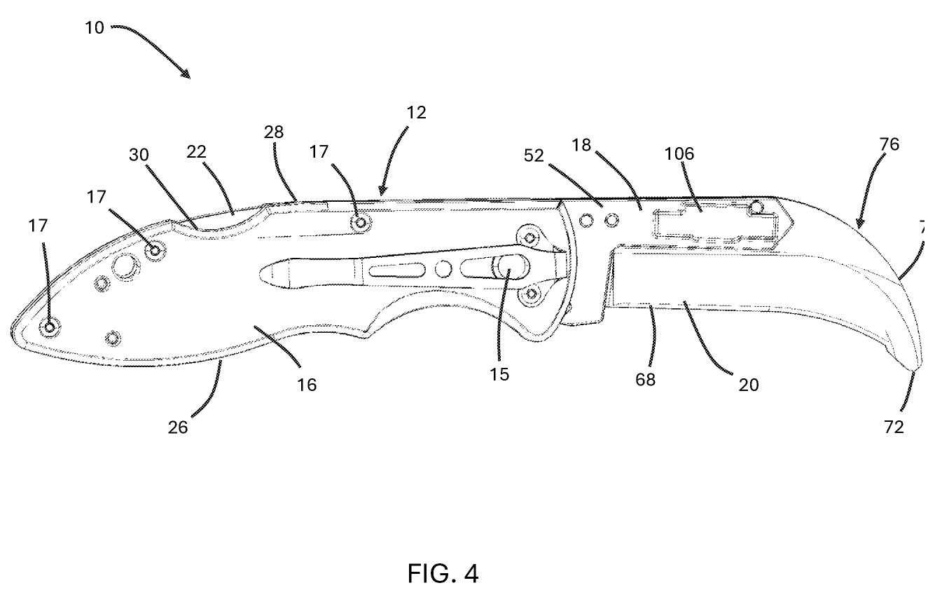

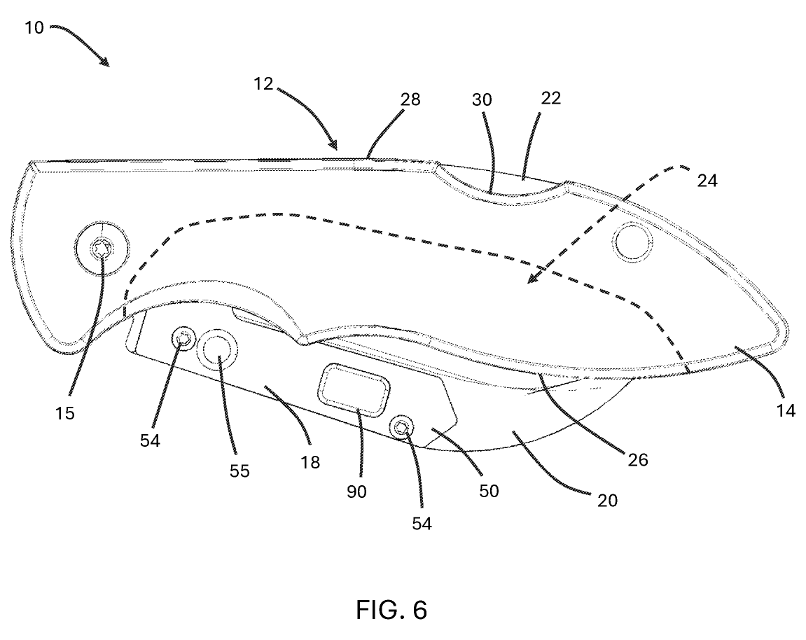

Referring to the drawings wherein identical reference numerals denote the same elements throughout the various views, FIGS. 1-6 illustrate an exemplary knife 10. Knife 10 includes a handle and/or an outer housing 12 having a left housing section 14 and a right housing section 16, a blade holder 18 pivotally connected between the left housing section 14 and the right housing section 16 by pivot 15, a blade 20 releasably connected to the blade holder 18, and a locking mechanism 22 to lock the blade 20 and blade holder 18 in an open position, FIG. 1. The blade 20 and blade holder 18 are adapted to move between the open position, FIG. 1, and closed position, FIG. 6. While the knife 10 is being described herein as having a pivotally connected blade holder 18 to allow the blade holder 18 and blade 20 to move between the open and closed position, it should be appreciated that the blade holder 18 and blade 20 may be fixed in the open position and, as such, the invention applies to both fixed and pivotally connected solutions.

As shown, the left housing section 14 and right housing section 16 sections are connected by fasteners 17 extending therethrough to create the outer housing 12. As shown in FIG. 6, when connected, the left housing section 14 and right housing section 16 form a slot 24 along a bottom 26 of the outer housing 12 for allowing the blade 20 to retract into an interior of the outer housing 12 when moved to the closed position. Along a top 28 of the outer housing 12, a recess 30 is formed to allow a user to depress locking mechanism 22 which allows the blade 20 to move from the open position, FIG. 1, to the closed position, FIG. 6.

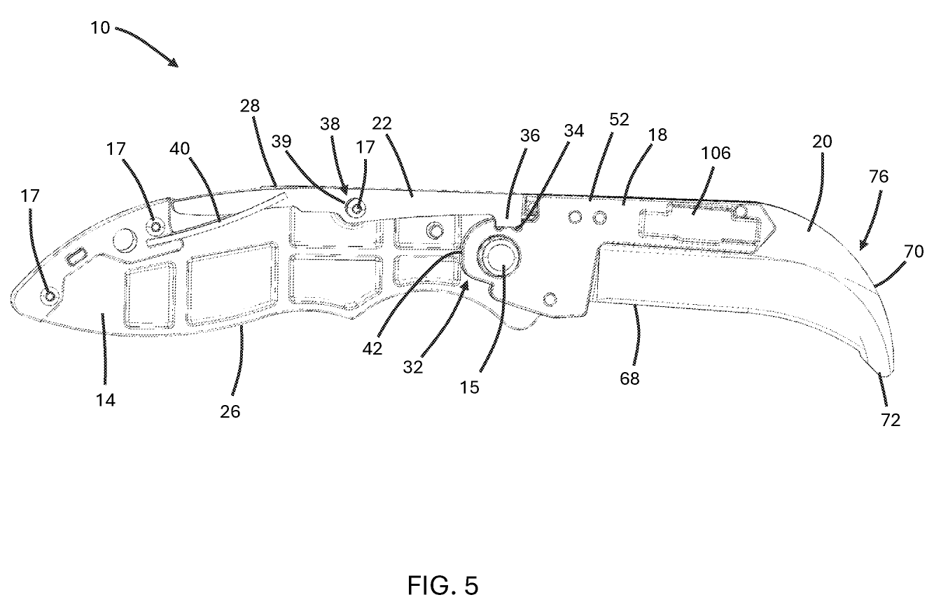

Referring to FIG. 5, the blade 20 and blade holder 18 are designed to lock in an open position to prevent accidental closing of the blade 20 which could cause serious injury. The blade holder 18 includes a pivot end 32 with a notch 34 adapted to mate with a tang 36 of the locking mechanism 22. As shown, the locking mechanism 22 is pivotally mounted about pivot 38 and biased towards a locking position by spring mechanism 40. As shown, the pivot 38 is a fastener 17 with a bushing 39; however, it should be appreciated, that other pivots may be used such as a pin secured between the left housing section 14 and right housing section 16. In operation, when moving the blade holder 18 from the closed position, FIG. 6, to the open position, FIG. 1, the tang 36 rides along an outside edge 42 of the pivot end 32 until the blade holder 18 reaches the open position. Once the blade holder 18 reaches the open position, the tang 36 slides into the notch 34 to lock the blade holder 18 and blade 20 in the open position. As discussed above, the spring mechanism 40 provides a spring force to keep the tang 36 in mating engagement with the notch 32.

To close the blade 20, a user depresses the blade locking mechanism 22 at recess 30, thereby causing the tang 36 to disengage the notch 34, thereby allowing a user to move the blade 20 from the open position, FIG. 1, to the closed position, FIG. 6. As shown, when moving the blade between the open and closed position, the pivot end 32 rotates about pivot 15. Pivot 15 may be a bushing, a pin, a fastener, a two-part fastener with a male end and a female end acting as a bushing, or any other suitable pivot. As shown, the pivot 15 has a male end secured to a female end which acts as a bushing.

The blade holder 18 includes a first blade holder section 50 and a second blade holder section 52. The first blade holder section 50 and second blade holder section 52 are secured together by fasteners 54. A slot 56 is formed between the first and second blade holder sections 50, 52 to receive the blade 20 therebetween. A thumb stud 55 is connected to the blade holder 18 to provide for quick one-handed opening of the blade 20. The thumb stud 55 may be positioned on the left or right side of the blade holder 18.

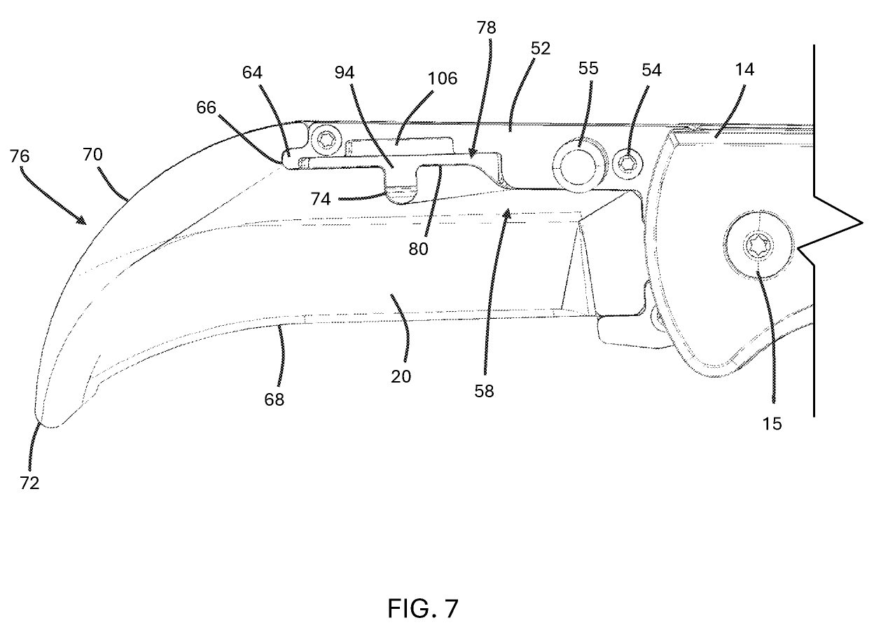

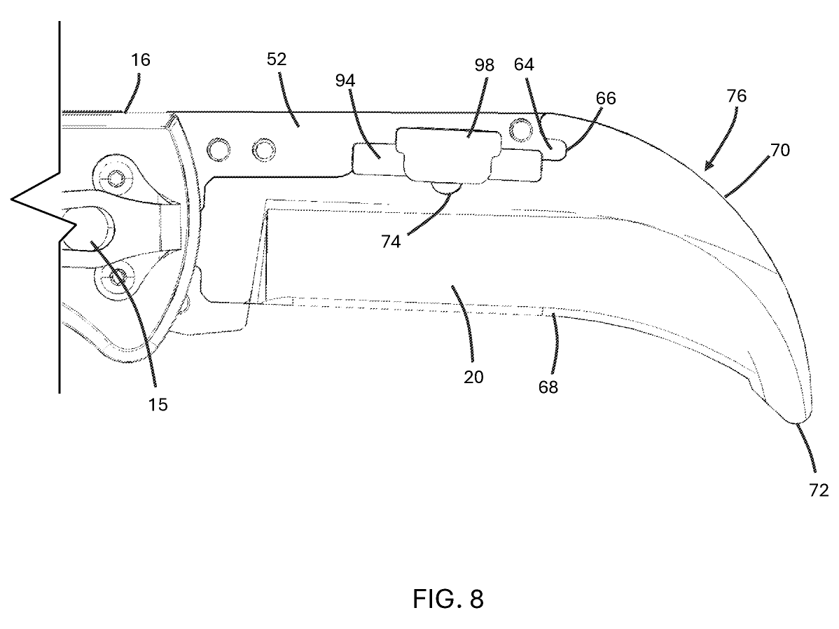

As shown in FIGS. 7-9, the second blade holder section 52 extends outwardly from the pivot end 32 and includes a receptacle 58 for mating engagement with the blade 20. More particularly, the second blade holder section 52 includes a pocket 60 for receiving a rear tang 62 of the blade 20 and a protrusion 64 for engaging a slot 66 of the blade 20. Together, the pocket 60 and protrusion 64 hold the blade 20 in a use position.

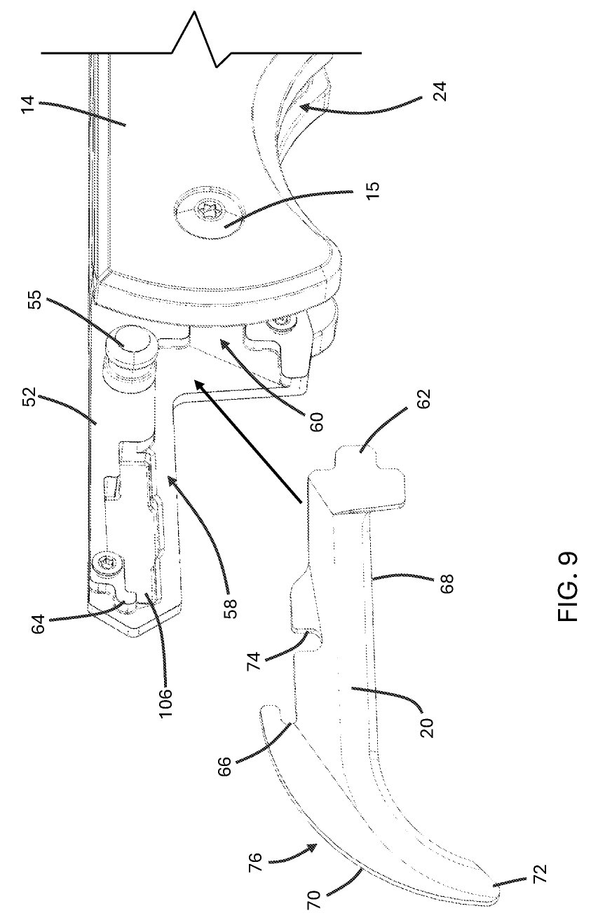

As illustrated, the blade 20 may have a cutting edge 68 that varies based on the use of the knife. Different cutting edges 68 are shown in FIGS. 7 and 9. The blade 20 may also be coated with a coating such as a black oxide coating to maximized durability and sharpness. As shown, the blade has an outer portion 76 visible when the blade 20 is secured in the blade holder 18 and a mating portion 78 for mating engagement with the receptacle 58. The outer portion 76 includes a rounded back or top 70 and blunted tip 72 to prevent injury. It should be appreciated that the outer portion 76 may also have a pointed tip 72 and/or squared top 70. In addition to the rear tang 62 and slot 66, the mating portion 78 includes a blade locking slot 74 disposed in a top edge 80 of the mating portion 78. As will be discussed in more detail below, the blade locking slot 74 prevents the blade 20 from disengaging the blade holder 18.

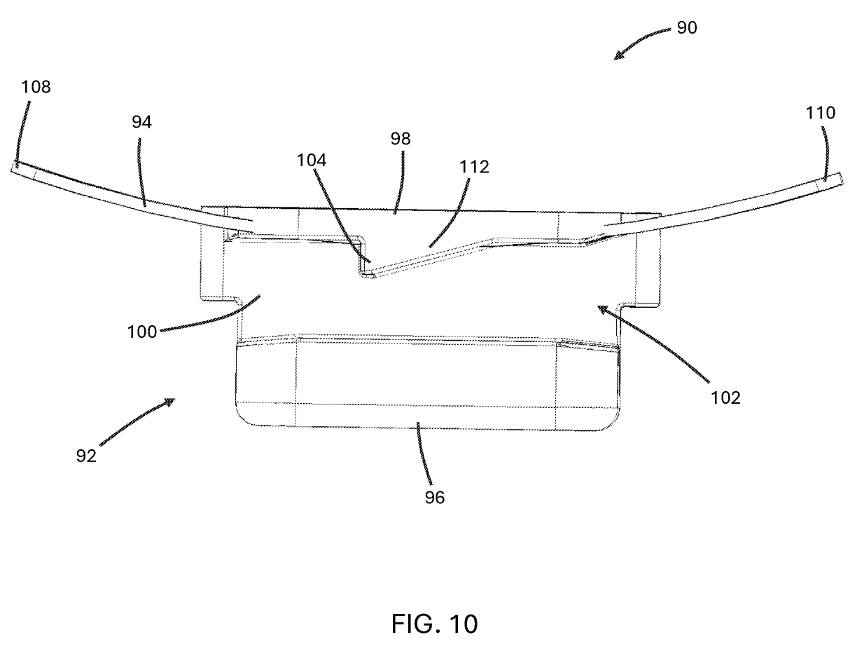

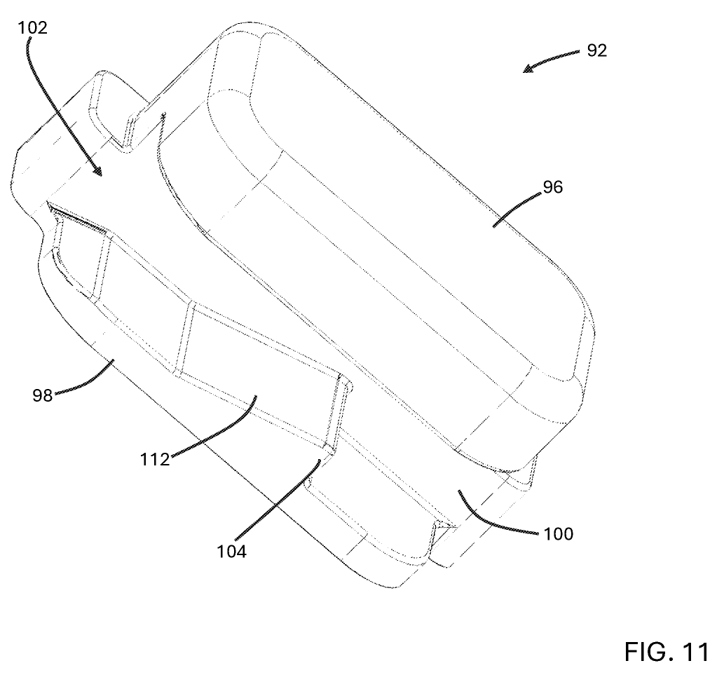

As illustrated in FIG. 1, the knife 10 includes a blade release mechanism 90 to allow the blade 20 to be released from the blade holder 18. The blade release mechanism 90 is shown in more detail in FIGS. 10-12. The blade release mechanism 90 includes an actuator 92 and spring 94 for biasing the actuator 92 in a locked position. The actuator 92 includes a front, user portion 96 adapted to allow a user to press the actuator 92 inwardly towards the second blade holder section 52, a rear portion 98, a bridge 100 interconnecting the front portion 96 and rear portion 98, and a slot 102 positioned between the front and rear portions 96, 98 and defined by the front portion 96, rear portion 98, and bridge 100. The rear portion 98 includes a protrusion or lock 104 extending from the rear portion 98 into the slot 102 to abut against the blade locking slot 74 and prevent the blade from disengaging the blade holder 18.

Spring 94 may be directly connected to the rear portion 98 of the actuator 92 or inserted through a slot in the rear portion 98 behind the lock 104. As shown in FIGS. 7-8 and 12, the spring 94 and rear portion 98 are adapted to be received by a recess 106 of the second blade holder section 52. As shown in FIG. 7, first and second ends 108, 110 of the spring 94 reside in the recess 106 and move along the recess 106 when the actuator 94 is pressed, thereby flattening the spring 94 when the actuator 92 is pressed.

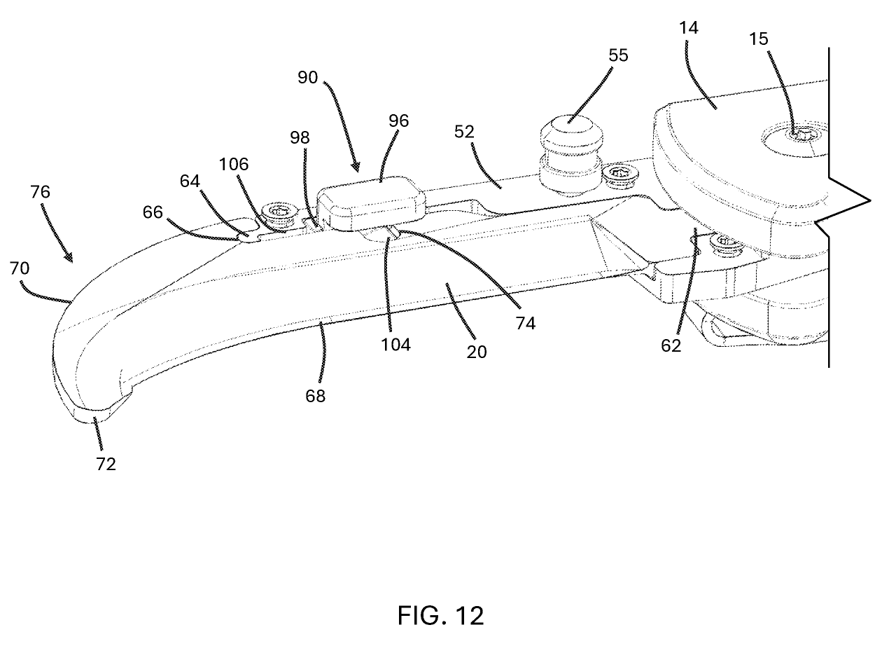

The bridge 100 of the actuator 92 extends through an aperture in the first blade holder section 50 such that the front portion 96 is positioned on an outer side of the first blade holder section 50 and the rear portion 98 is positioned in the recess 106. When the blade 20 is installed, FIG. 12, the blade 20 is positioned between the front and rear portions 96, 98 and the bridge resides above mating portion 78 of the blade 20. The lock 104 is positioned in and engages the blade locking slot 74.

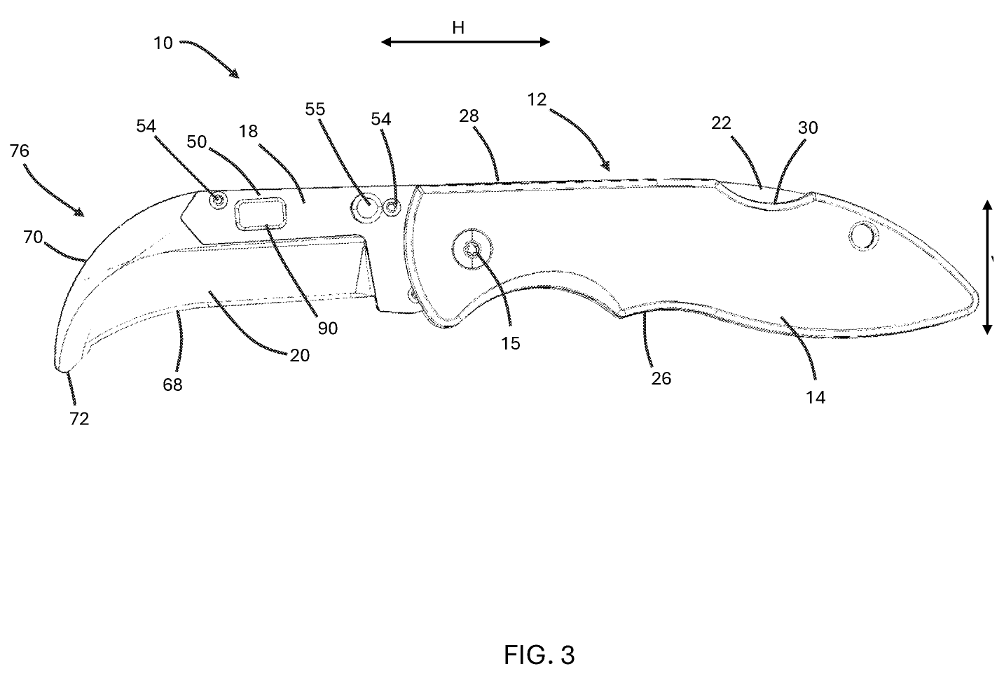

In use, blade 20 is installed into the blade holder 18 by pushing the blade 20 inwardly into the slot 56 such that the mating portion 78 is received into the receptacle 58 of the second blade holder section 52. This causes the rear tang 62 of the blade 20 to engage the pocket 60 of the second blade holder section 52 and protrusion 64 to engage slot 66. Lock 104 of the blade locking mechanism 90 engages blade locking slot 74 to prevent the blade 20 from being removed from the blade holder 18. When the blade 20 is inserted into the slot 56, the blade 20 slides across a ramp 112 of the lock 104, thereby pushing the rear portion 98 of the blade locking mechanism 90 into the recess 106 and flattening the spring 94. Once the blade locking slot 74 and lock 104 align, the lock is snapped into engagement with the blade locking slot 74 by the spring 94. In an installed position, the mating design of the blade 20 and blade holder 18 prevents the blade 20 from moving vertically "V" (FIG. 3) and horizontally "H" (FIG. 3).

To release the blade 20 from the blade holder 18, a user presses the front portion 96 of the actuator 92 so that the rear portion 98 of actuator 92 is pressed into the recess 106 of the second blade holder section 52, thereby flattening the spring 94 and moving the lock 104 from engagement with the blade locking slot 74 to disengagement with the blade locking slot 74. While pressing the front portion 96, the user then grabs the outer portion 76 of the blade 20 and slides the blade 20 out of engagement with the blade holder 18. A new blade 20 may then be installed into the blade holder 18.

The foregoing has described a knife. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

What is claimed is:

1. A knife, comprising:
a housing;
a blade holder connected to the housing;
a blade in mating engagement with and releasably secured to the blade holder; and
a blade release mechanism connected to the blade holder, the blade release mechanism securing the blade in the blade holder and releasing the blade when an actuator of the blade release mechanism is depressed.

2. The knife of claim 1, wherein the blade release mechanism includes a spring to bias the actuator in a locked position.

3. The knife of claim 1, wherein the actuator includes a front portion, a rear portion, and a bridge connecting the front portion to the rear portion, the front portion, rear portion and bridge defining a slot between the front portion and rear portion.

4. The knife of claim 3, further including a protrusion extending from the rear portion into the slot.

5. The knife of claim 4, wherein the blade includes a blade locking slot, the blade locking slot engaging the protrusion to lock the blade in the blade holder.

6. The knife of claim 1, wherein the blade holder includes a receptacle for receiving the blade therein.

7. The knife of claim 1, wherein the blade holder includes a pocket for receiving a rear tang of the blade therein.

8. The knife of claim 1, wherein the blade holder includes a protrusion for engaging a slot of the blade.

9. The knife of claim 1, wherein the blade holder includes a recess for receiving a spring and rear portion of the actuator therein.

10. A knife, comprising:
a housing;
a blade holder connected to the housing, the blade holder defining a receptacle;
a blade releasably secured in the receptacle of the blade holder, the blade having a rear tang for engagement with a pocket of the blade holder and a slot for engagement with a protrusion of the blade holder; and
a blade release mechanism connected to the blade holder, the blade release mechanism securing the blade in the blade holder and releasing the blade when an actuator of the blade release mechanism is depressed.

11. The knife of claim 10, wherein the blade further includes a blade locking slot.

12. The knife of claim 11, wherein the actuator includes a protrusion extending from a rear portion of the actuator into a slot of the actuator, the protrusion engaging the blade locking slot when the blade is secured in the receptacle to prevent the blade from pulling out of the receptacle.

13. The knife of claim 10, wherein the blade release mechanism further includes a spring, the spring biasing the actuator in a locked position.

14. The knife of claim 10, wherein the actuator further includes a protrusion extending from a rear portion of the actuator into a slot of the actuator, the protrusion including a ramped section to allow the blade to be pushed into the receptacle of the blade holder.

15. The knife of claim 13, wherein the blade holder further includes a recess for receiving at least a portion of the spring and a rear portion of the actuator therein.

16. A knife, comprising:
a housing;
a blade holder connected to the housing and defining a receptacle therein;
a blade releasably secured to the blade holder, the blade including a mating portion, the mating portion mating with the receptacle of the blade holder when the blade is secured therein; and
a blade release mechanism connected to the blade holder, the blade release mechanism securing the blade in the receptacle of the blade holder and releasing the blade when an actuator of the blade release mechanism is depressed.

17. The knife of claim 16, wherein the mating portion includes a slot for engaging a protrusion of the blade holder and a rear tang for engaging a pocket of the blade holder to secure the blade in the receptacle and prevent the blade from moving in a vertical direction relative to the blade holder.

18. The knife of claim 17, wherein the mating portion further includes a blade locking slot, the blade locking slot engaging a protrusion of the actuator to secure the blade in the receptacle and prevent the blade from moving in a horizontal direction relative to the blade holder.

19. The knife of claim 16, wherein the blade release mechanism further includes a spring, the spring biasing the actuator in a locked position.

20. The knife of claim 16, wherein the actuator includes a front portion, a rear portion, a bridge interconnecting the rear portion and front portion, and a slot defined by the front portion, rear portion, and bridge.
